(19) United States
(12) Patent Application Publication
(10) Pub. No.: US 2009/0250305 A1
(43) Pub. Date: Oct. 8, 2009

(54) STARTING CLUTCH

(75) Inventor: Manabu Sawayanagi, Fukuroi-shi (JP)

Correspondence Address: MILES & STOCKBRIDGE PC, 1751 PINNACLE DRIVE, SUITE 500, MCLEAN, VA, 22102-3833, US

(73) Assignee: NSK-WARNER K.K.

(21) Appl. No.: 12/419,318

(22) Filed: Apr. 7, 2009

(30) Foreign Application Priority Data
Apr. 8, 2008 (JP) 2008-100315

(51) Int. Cl. F16D 13/72

(52) U.S. Cl. 192/70.12

(57) ABSTRACT

A starting clutch is disposed between a transmission and an engine and including a wet type multi-plate clutch adapted to transmit a power. The wet type multi-plate clutch comprises a plurality of friction engaging elements housed for an axial sliding movement, a clutch drum for accommodating the friction engaging elements, a clutch hub disposed at an inner diameter side of the clutch drum to support the friction engaging elements for the axial sliding movement, and a piston for applying a pressing force to the friction engaging elements to tighten the wet type multi-plate clutch. The starting clutch includes a housing adapted to accommodate the wet type multi-plate clutch and driven by the engine, and in a condition that oil is filled within the starting clutch, the oil supplied to the housing is flown along an outer periphery of the clutch drum and is discharged from the housing.

This application claims priority from Japanese Patent Application No. 2008-100315 filed Apr. 8, 2008, which is hereby incorporated by reference herein.

### BACKGROUND OF THE INVENTION

1. Field of the Invention

The present invention relates to a starting clutch utilizing a wet type multi-plate clutch, which is used in place of a conventional automatic transmission utilizing a torque converter and which reduces power transmitting loss caused by fluid slip of the torque converter thereby to enhance reduction in fuel consumption.

2. Related Background Art

Conventionally, in automatic transmissions (i.e. ATs), the starting of a vehicle was performed by torque transmitting through a torque converter. The torque converter was mounted to many vehicles having the automatic transmission since the torque converter has a torque amplifying effect and provides smooth torque transmission.

On the other hand, the torque converter has a disadvantage that a large amount of slip is generated during the torque transmission to increase the power transmitting loss and, thus, the torque converter has less efficiency.

Therefore, in recent years, there has been proposed a technique in which a starting clutch is used in place of the torque converter, and the torque has been amplified at a low speed range by reducing a gear ratio and by increasing the number of speed change stages.

In general, the starting clutch includes a wet type multi-plate clutch housed in a clutch drum. In the multi-plate clutch, friction plates as friction engaging elements at an output side and separator plates as friction engaging elements at an input side are arranged alternately along an axial direction. With this arrangement, a power is transmitted by engaging the friction plates with the separator plates by means of a piston.

In the starting clutch utilizing the wet-type multi-plate clutch, upon ON/OFF of the clutch during the starting operation or the speed changing operation, frictional heat generated by slipping movements in a wet type multi-plate clutch portion is accumulated in the wet type multi-plate clutch portion, which may cause seizure and/or wear of the friction plates of the wet type multi-plate clutch.

Further, the heat generated in the wet type friction plate portion of the starting clutch is transmitted to metal materials such as a clutch drum, a clutch hub and the like which has good thermal conductivity.

In conventional starting clutches, in many cases, oil was directly supplied to friction engaging portions of the wet type multi-plate clutch, so that the oil could not positively cool the clutch drum and the clutch hub to which the frictional heat was transmitted. Thus, the heat was accumulated in the clutch drum and the clutch hub to increases temperatures thereof, with the result that the heat generated in the wet type multi-plate clutch could not be transferred or transmitted to the clutch drum and the clutch hub smoothly. To cope with this, a large amount of cooling oil must be supplied to the wet type multi plates directly to cool the wet type multi plates. This may cause problems that the reduction in fuel consumption cannot be enhanced and that heat resistance of the starting clutch is reduced due to the fact that the wet type friction plates cannot be well cooled.

Japanese Patent Application Laid-open No. 2002-357232 discloses a starting clutch including a plurality of holes capable of sending a large amount of lubricant oil to cool the clutch and of discharging the lubricant oil in a radial direction of a clutch drum. In this case, however, since the lubricant oil is discharged from a clutch portion quickly, heat exchange between the clutch portion and the oil becomes inadequate, with the result that the cooling efficiency for the clutch is worsened and the heat is apt to be accumulated in the clutch portion. Further, as is in U.S. Pat. No. 6,929,105, if the clutch is filled with the oil, although the heat in the clutch portion is transmitted to the oil, since the oil is stayed in the clutch portion excessively, with the result that, similar to the above-mentioned Japanese Patent Application Laid-open No. 2002-357232, the heat cannot be removed from the clutch portion smoothly.

### SUMMARY OF THE INVENTION

Accordingly, an object of the present invention is to provide a starting clutch in which reliability can be enhanced by removing heat from a wet type multi-plate clutch efficiently.

To achieve the above object, the present invention provides a starting clutch disposed between a transmission and an engine and including a wet type multi-plate clutch adapted to transmit a power; wherein that the wet type multi-plate clutch comprises a plurality of friction engaging elements housed for an axial sliding movement, a clutch drum for accommodating the friction engaging elements, a clutch hub disposed at an inner diameter side of the clutch drum to support the friction engaging elements for the axial sliding movement, and a piston for applying a pressing force to the friction engaging elements to tighten or engage the wet type multi-plate clutch and wherein the starting clutch includes a housing adapted to accommodate the wet type multi-plate clutch and driven by the engine and further wherein the clutch hub is engaged by the housing so that, in a condition that oil is filled within the starting clutch, the oil is flown along an outer periphery of the clutch drum.

According to the starting clutch of the present invention, the following effects can be obtained. By cooling the clutch drum and the clutch hub positively, frictional force generated in the wet type multi-plate clutch can be transmitted to the clutch drum and the clutch hub quickly to achieve excellent cooling of the wet type multi-plate clutch. In particular, by cooling the clutch drum engaged by separator plates each of which has great thermal conductivity for the frictional heat, the excellent cooling of the wet type multi-plate clutch can be achieved.

Further, since the oil can flow within the housing smoothly, accumulation of heat can be eliminated, thereby preventing deterioration of the oil.

Since the cooling oil flows along the outer periphery of the wet type multi-plate clutch in the housing within which the oil is filled, the oil can be flown smoothly from the inner diameter portion to the outer diameter portion and from the outer diameter portion to the inner diameter portion and be returned to an oil cooler disposed at a transmission side.

In this case, the oil can absorb or remove the heat efficiently from the clutch drum and the clutch hub, thereby cooling the clutch drum and the clutch hub.

Thus, the heat generated in the wet type multi-plate clutch is transferred particularly to the clutch drum with which the separator plates having metallic friction surfaces are engaged and is also transferred to the clutch hub with which the friction plates having friction materials adhered thereto are engaged (in this case, a heat amount transferred to the clutch hub is smaller than a heat amount transferred to the clutch drum), thereby enhancing the cooling of the wet type multi-plate clutch.

Accordingly, in comparison with the conventional techniques, the clutch can be cooled efficiently even with a smaller amount of oil.

Further, by designing so that oil is also supplied to the friction plate portions and through ports are provided in the outer diameter portion of the clutch drum as is in the conventional cases, the oil discharged directly from the friction plate portions to the outer diameter portion is entrained by the oil flowing along the outer periphery, with the result that the wet type friction plate portions can be cooled more effectively, thereby enhancing the heat resistance of the starting clutch.

Further features of the present invention will become apparent from the following description of exemplary embodiments with reference to the attached drawings.

### BRIEF DESCRIPTION OF THE DRAWINGS

FIG. 1 is an axial sectional view of a starting clutch according to a first embodiment of the present invention.

FIG. 2 is an axial sectional view of a starting clutch according to a second embodiment of the present invention.

### DETAILED DESCRIPTION OF THE INVENTION

Now, embodiments of the present invention will be fully explained with reference to the accompanying drawing. Incidentally, the illustrated embodiments are merely examples of the present invention, and it should be noted that other alterations can be made with the scope of the present invention.

### First Embodiment

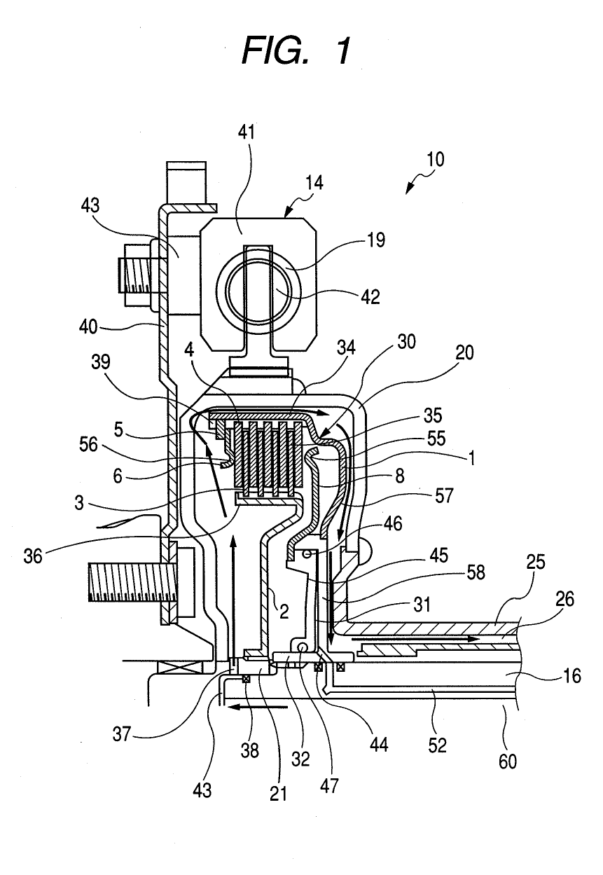

FIG. 1 is an axial sectional view of a starting clutch according to a first embodiment of the present invention. The starting clutch 10 comprises a clutch housing 20 and a wet type multi-plate clutch 30 housed in the housing. The wet type multi-plate clutch 30 includes a plurality of friction plates 3 and a plurality of separator plates 4 which are housed for axial sliding movements, a clutch drum 1 for accommodating the separator plates 4, a clutch hub 2 disposed at an inner diameter side of the clutch drum 1 to support the friction plates 3 for an axial sliding movement, and a piston 8 for applying a pressing force to the friction plates 3 and the separator plates 4 to tighten or engage the wet type multi-plate clutch 30.

The substantially annular friction plates 3 as friction engaging elements at an input side and the substantially annular separator plates 4 as friction engaging elements at an output side are alternately arranged in an axial direction. At an axial one end (open end) of the clutch drum 1, a substantially annular backing plate 6 is fixedly supported by a substantially annular stop ring 5 in the axial direction, thereby holding the separator plate 4.

The annular clutch drum 1 is provided at its inner peripheral central area with a cylindrical portion 32 and is also provided at its outer periphery with an outer diameter portion or a drum portion 34 opposed to the cylindrical portion 32 in a radial direction. Between the cylindrical portion 32 and the drum portion 34, there are provided an outer diameter portion 57 extending from the drum portion 34 and an inner diameter portion 58 connected to the outer diameter portion 57. The inner diameter portion 58 is formed integrally with the cylindrical portion 32. The drum portion 34 is provided at its inner periphery with a spline portion 39 with which the separator plates 4 are engaged for an axial sliding movement. Further, the cylindrical portion 32 is fitted on an input shaft 16 connected to a transmission (not shown).

In the illustrated embodiment, although the wet type multi-plate clutch 30 is constituted by four friction plates 3 and five separator plates 4, it should be noted that the number of the input and output side friction engaging elements can be changed voluntarily in accordance with required torque. Further, a substantially annular friction material 35 or a plurality of friction material segments 35 are secured to each of axial both surfaces of the friction plate 3 by an adhesive or the like. Further, the friction materials 35 may be secured to one of surfaces of the friction plate 3 and the separator plate 4 alternately.

In FIG. 1, within the clutch drum 1, near a closed end of the clutch drum 1, a piston 8 is fitted on an outer periphery of the cylindrical portion 32 for an axial sliding movement, and, between an inner diameter portion 8 of the piston 8 and the clutch drum 1, a hydraulic chamber 31 for applying oil pressure to the piston 8 is defined.

Although not shown in the drawings, there may provided a spring for applying a predetermined pressing force to the piston 8 to always bias the piston 8 toward the hydraulic chamber 31 i.e. toward a clutch releasing or disengaging direction.

An axially protruding projection or ridge 55 having an arc cross-section is provided on a surface of the piston 8 which is confronting to the separator plate 4. And, at the opposite side, although the separator plate 4 is urged against the backing plate 6, an axially protruding projection or ridge 56 having an arc cross-section is provided on the backing plate. In a condition that the separator plates are pinched between the projection 55 and the projection 56, when the separator plates 4 are pressed at their load acting points thereof or therearound, the friction surfaces of all of the plates are contacted with each other throughout the entire engaging surfaces thereof with uniform face pressure, thereby tightening the wet type multi-plate clutch 30. Further, due to the uniform face pressure, offset or eccentricity of the heat generating portions can be prevented, thereby improving the heat resistance of the clutch portion.

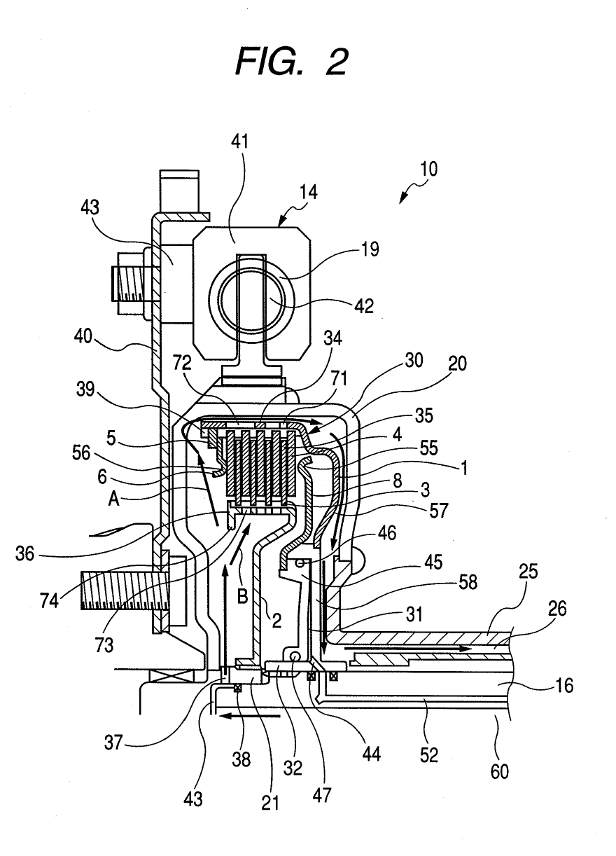

The clutch hub 2 fitted on a boss portion 21 of the housing 20 to be rotated together with the housing 20 is provided at its outer periphery with a friction engaging element engaging portion or spline portion 36. The friction plates 3 are fitted in the spline portion 36 for an axial sliding movement. The clutch drum 1 and the clutch hub 2 have their opening portions directed toward the engine (not shown) (left side in FIGS. 1 and 2).

As shown in FIG. 1, a shock absorbing mechanism or damper device 14 for absorbing shock generated upon the engagement of the clutch is provided on an outer periphery of the housing 20. The damper device 14 is constituted by a retainer plate 41 for holding a spring 19, and a pawl member 42 attached to the outer periphery of the housing 20 via the spline connection. Although the pawl member 42 is rotated as the housing 20 is rotated, the shock is dampened by the spring 19. The retainer plate 41 is secured to a drive plate 40 by a joining member 43.

In the starting clutch 10 having the above-mentioned construction, a power inputted from the engine (not shown) is transmitted to a transmission (not shown) through a path including the drive plate 40, damper device 14, housing 20, clutch hub 2, wet type multi-plate clutch 30, clutch drum 1 and input shaft 16.

The input shaft 16 of the transmission which is also an output shaft to which the power is transmitted from the engine is provided with an oil supplying path 52 extending in the axial direction. Hydraulic oil used for operating the piston 8 and supplied from a supplying source (not shown) is supplied to the hydraulic, chamber 31 which is maintained in an oil-tight condition by a plurality of seal members 46 and 47, through the oil supplying path 52 and a radial through port 44 provided in the cylindrical portion 32 of the clutch drum 1.

An axial one end portion (near the engine) of the input shaft 16 is provided at its outer periphery with a spline portion onto which the cylindrical portion 32 of the clutch drum 1 is spline-fitted. With this arrangement, the input shaft 16 is rotated integrally with the clutch drum 1.

On the other hand, as mentioned above, the clutch hub 2 is spline-connected to the boss portion 21 of the housing 2 to be rotated integrally with the housing 20. The boss portion 21 of the housing 20 is fitted on the input shaft 16. An O-ring 37 is interposed between the boss portion 21 and the input shaft 16.

The input shaft 16 is provided with an axially extending lubricant oil supplying path 60 which is different from the oil supplying path 52 so that (lubricant) oil supplied from a lubricant oil supplying source (not shown) is supplied to the wet type multi-plate clutch 30. The lubricant oil supplying path 60 is opened at an axial end face of the input shaft 16 so that the lubricant oil is passed through a radially extending through port 37 provided in the boss portion 21 via a passage 43 defined between the housing 20 and the output shaft 16 and enters into the starting clutch 10, thereby lubricating the wet type multi-plate clutch 30.

At a side opposite to the engine, the housing 20 is provided with an extension 25 into which the input shaft 16 is fitted. An axially extending lubricant oil discharging path 26 is formed in the extension 25. The lubricant oil discharging path 26 is communicated with a space defined between the housing 20 and the clutch drum 1. As shown in FIG. 1, a predetermined space is defined between the outer periphery of the clutch drum 1 and the housing 20.

The lubricant oil is supplied from the lubricant oil supplying path 60 and is filled or loaded in the housing 20 of the starting clutch 10. In a condition that the lubricant oil is filled, almost all of the lubricant oil supplied from the lubricant oil supplying path 60 flows in a direction shown by the arrows in FIG. 1. The lubricant oil supplied from the lubricant oil supplying path 60 and passed through the through port 37 of the boss portion 21 and entered into the starting clutch 10 is filled within the wet type multi-plate clutch 30 to lubricate the wet type multi-plate clutch 30.

When the starting clutch 10 and the wet type multi-plate clutch 30 are filled with the lubricant oil, almost all of the lubricant oil passes through the clutch hub 2 and flows along the inner periphery of the housing 20, as shown by the arrows in FIG. 1. That is to say, the lubricant oil passes between the drum portion 34 of the clutch drum 1 and the inner surface of the housing 20 and between the outer diameter portion 57 of the clutch drum 1 and the inner surface of the housing 20 and between the inner diameter portion 58 of the clutch drum 1 and the inner surface of the housing 20 and enters into the lubricant oil discharging path 26, and, thereafter, the lubricant oil is discharged to an oil cooler (not shown). In this case, the lubricant oil removes the heat from the clutch drum 1 and the clutch hub 2 efficiently, thereby cooling the clutch drum 1 and the clutch hub 2 effectively.

In this way, in the condition that the lubricant oil is filled, since the lubricant oil flows along the outer periphery of the clutch drum 1, the heat can be removed from the wet type multi-plate clutch 30 efficiently, thereby enhancing the entire cooling efficiency for the starting clutch 10. By cooling the clutch drum 1 and the clutch hub 2 positively in this way, the frictional heat generated in the wet type multi-plate clutch 30 can be transmitted to the clutch drum 1 and the clutch hub 2 quickly, thereby obtaining the excellent cooling effect for the wet type multi-plate clutch.

Further, since the lubricant oil flows in the housing 20 smoothly, the heat can be prevented from being accumulated in the starting clutch 10, thereby preventing deterioration of the lubricant oil.

Thus, since the heat generated in the wet type multi-plate clutch 30 is transmitted to the clutch drum 1 and the clutch hub 2 efficiently and the wet type multi-plate clutch is cooled by the lubricant oil, the cooling of the wet type multi-plate clutch 30 is promoted. Accordingly, in comparison with the conventional cases, the clutch can be cooled efficiently even with smaller amount of lubricant oil.

In general, a major part of the frictional heat generated during the engagement of the clutch is transmitted from the separator plates toward the clutch drum 1. On the other hand, in the friction plates 3 to which the friction materials 35 are adhered, since the friction materials 35 act as thermal insulators, the heat is less transmitted toward the clutch hub 2. In this case, in the condition that a large amount of friction heat is transferred from the separator plates 4 to the clutch drum 1, by flowing the lubricant (oil) cooled by the oil cooler (not shown) along the outer periphery of the clutch drum 1, the heat is removed from the clutch drum 1, and then, the oil is discharged out of the housing 20, and thereafter, by circulating the lubricant oil cooled by the oil cooler, the starting clutch can be cooled efficiently.

### Second Embodiment

Next, a second embodiment of the present invention will be explained with reference to FIG. 2. FIG. 2 is an axial sectional view of a starting clutch according to the second embodiment of the present invention. Since a fundamental construction of the starting clutch of the second embodiment is the same as that of the first embodiment, only differences will be described.

As can be seen from FIG. 2, in the second embodiment, constructions of clutch drum 1 and clutch hub 2 differ from those in the first embodiment. An outer diameter portion or drum portion 34 of a clutch drum 1 is provided with oil ports 71 and 72 extending through the drum portion in a radial direction. The oil ports 71 and 72 extend through a wet type multi-plate clutch 30 from its inner diameter side to its outer diameter side. That is to say, such oil ports are arranged so that the lubricant oil which has lubricated the clutch portion in which the friction engaging elements are engaged with each other flows from the inner diameter side to the outer diameter side and, thus, is directed to the outer periphery of the clutch drum 1.

While an example that an axial width of the oil port 71 is smaller than an axial width of the oil port 72 was explained, the axial widths of both oil ports may be the same. Further, the number of the oil ports may be one or three or more, rather than two.

Oil port(s) 73 extending from an inner diameter portion to an outer diameter portion are formed in a spline portion 36 of a clutch hub 2. The oil port 73 is designed to extend from the clutch hub 2 to the wet type multi-plate clutch 30, i.e. from the inner diameter side to the outer diameter side. The number of the oil ports 73 can be selected voluntarily to be, for example, one, two, four or more, if necessary.

A dam portion 74 extending radially inwardly from the spline portion 36 is formed at an open end of the spline portion 36 of the clutch hub 2. By providing the dam portion 74, the lubricant oil entered into the starting clutch 10 through a through port 37 formed in a boss portion 21 of the housing 20 can be divided into an oil flow shown by the arrow A and directed toward the outer periphery of the clutch drum 1 and an oil flow shown by the arrow B and directed toward the clutch portion of the wet type multi-plate clutch 30.

The lubricant oil flowing along the direction shown by the arrow B serves to lubricate the clutch portion including the friction engaging elements and then is discharged out of the clutch drum 1 through the oil ports 71 and 72 and then is joined to the oil flow shown by the arrow A.

According to the second embodiment, adequate lubricant oil can also be supplied the clutch portion of the wet type multi-plate clutch 30. Further, since the lubricant oil discharged from the clutch portion is entrained by the lubricant oil flowing along the outer periphery of the clutch drum 1 to accelerate the discharging of the oil, the clutch portion can be cooled more effectively, thereby enhancing the heat resistance of the starting clutch 10.

Further, by designing so that oil is also supplied to the friction plate portions and through ports are provided in the outer diameter portion of the clutch drum as is in the conventional cases, the oil discharged directly from the friction plate portions to the outer diameter portion is entrained by the oil flowing along the outer periphery, with the result that the wet type friction plate portions can be cooled more effectively, thereby enhancing the heat resistance of the starting clutch.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A starting clutch disposed between a transmission and an engine and including a wet type multi-plate clutch adapted to transmit a power, wherein:
said wet type multi-plate clutch comprises a plurality of friction engaging elements housed for an axial sliding movement, a clutch drum for accommodating said friction engaging elements, a clutch hub disposed at an inner diameter side of said clutch drum to support said friction engaging elements for the axial sliding movement, and a piston for applying a pressing force to said friction engaging elements to tighten said wet type multi-plate clutch;
and wherein
said starting clutch includes a housing adapted to accommodate said wet type multi-plate clutch and driven by said engine;
and further wherein
in a condition that oil is filled within said starting clutch, the oil supplied to said housing is flown along an outer periphery of said clutch drum and is discharged from said housing.

2. A starting clutch according to claim 1, wherein the oil is supplied from between said housing and said clutch drum at a side of said engine and is returned to a side of said transmission from between said housing and said clutch drum at an opposite side of said engine.

3. A starting clutch according to claim 1, wherein said clutch hub is engaged by a boss portion of said housing and said clutch drum is engaged by an input shaft of said transmission.

4. A starting clutch according to claim 1, wherein said clutch drum is provided at its inner periphery with a spline portion with which said friction engaging elements are slidably engaged.

5. A starting clutch according to claim 4, wherein said friction engaging element engaged by said spline portion is a separator plate and said friction engaging element engaged by said clutch hub is a friction plate on which a friction material is provided.

6. A starting clutch according to claim 1, wherein said clutch drum and said clutch hub is opened toward said engine.

7. A starting clutch according to claim 1, wherein an oil port extending from an inner diameter portion to an outer diameter portion is provided in a friction engaging element engaging portion of said clutch hub.

8. A starting clutch according to claim 1, wherein a dam portion extending radially inwardly is provided at an end face of an opening portion of the inner diameter portion of said friction engaging element engaging portion of said clutch hub.

9. A starting clutch according to claim 1, wherein an oil port extending from an inner diameter portion of a friction engaging element engaging portion to an outer diameter portion of said clutch drum is provided in said outer diameter portion of said clutch drum.

10. A starting clutch according to claim 1, wherein a damper secured to a drive plate is engaged by said housing.
